(19) United States
(12) Patent Application Publication
(10) Pub. No.: US 2025/0260149 A1
(43) Pub. Date: Aug. 14, 2025

(54) PHASE SHIFTER AND ANTENNA DEVICE

(71) Applicant: NEC Corporation, Tokyo (JP)

(72) Inventors: Ryota NIHEI, Tokyo (JP); Kohei Yoshida, Tokyo (JP); Fujio Okumura, Kanagawa (JP)

(73) Assignee: NEC Corporation, Tokyo (JP)

(21) Appl. No.: 18/991,861

(22) Filed: Dec. 23, 2024

(30) Foreign Application Priority Data
Feb. 9, 2024 (JP) 2024-018569

(51) Int. Cl. H01P 1/18; H01Q 3/36; H01Q 21/06

(52) U.S. Cl. CPC H01P 1/18; H01Q 3/36; H01Q 21/065

(57) ABSTRACT

A phase shifter including an input line, a variable phase shift circuit connected to the input line and having a line formation layer made of vanadium dioxide, and an output line connected to the variable phase shift circuit. The variable phase shift circuit includes a plurality of heat generating elements arranged in an array form along one surface of the line formation layer, and a heat generation drive circuit arranged in association with each of the plurality of heat generating elements. Each of the plurality of heat generating elements is thermally connected to the line formation layer.

This application is based upon and claims the benefit of priority from Japanese Patent Application No. 2024-018569, filed on Feb. 9, 2024, the disclosure of which is incorporated herein in its entirety by reference.

### TECHNICAL FIELD

The present disclosure relates to a phase shifter and an antenna device.

### BACKGROUND ART

For mobile communication after the fifth generation mobile communication, an antenna device compatible with radio waves in a high frequency band has been developed. For example, examples of such an antenna device include a phased array antenna configured by a plurality of antenna elements. The phased array antenna can form a beam having a desired directivity by changing an excitation phase of an antenna element using a phase shifter mounted on a pre-stage of the antenna element. For example, since a phase shift range up to 360 degrees can be covered by using a switched line phase shifter, in such a way that a large scanning angle can be achieved. However, it is difficult to incorporate such a phase shifter in a small antenna device having a plurality of patch antennas.

PTL 1 (Japanese Patent Application Laid-Open No. 2019-029722) discloses a reflection-type variable phase shifter intended to continuously change a phase. The variable phase shifter of PTL 1 includes a 90 degree hybrid circuit, a pair of switches, a pair of first variable reactance elements, a pair of first stubs, and a pair of second variable reactance elements. The 90 degree hybrid circuit has a first port, a second port, a third port, and a fourth port. With respect to an input of a signal from the first port, the 90 degree hybrid circuit outputs the signal to the second port and the third port with a phase difference of 90 degrees and does not output the signal to the fourth port. The switch is provided in each of the second port and the third port. The first variable reactance element is connected to each of the pair of switches. The switch is connected to one end of the first stub. The second variable reactance element is connected to the other end of the first stub. The switch switches between connection with the first variable reactance element and connection with one end of the first stub.

According to the variable phase shifter of PTL 1, the phase shift amount can be changed by switching the connection between the second port and the third port of the 90 degree hybrid circuit and the variable reactance element and the stub. In the variable phase shifter of PTL 1, the phase shift change amount depends on the length of the stub. In the variable phase shifter of PTL 1 a plurality of stubs having different line lengths are provided to achieve continuous phase shift change. Therefore, in the variable phase shifter of PTL 1, a space for arranging a plurality of stubs having different line lengths is required.

An object of the present disclosure is to provide a phase shifter and an antenna device having a compact configuration capable of achieving continuous phase shift change.

### SUMMARY

According to an aspect of the present disclosure, a phase shifter of the present disclosure includes an input line, a variable phase shift circuit connected to the input line and having a line formation layer made of vanadium dioxide, and an output line connected to the variable phase shift circuit. The variable phase shift circuit includes a plurality of heat generating elements arranged in an array form along one surface of the line formation layer, and a heat generation drive circuit arranged in association with each of the plurality of heat generating elements. Each of the plurality of heat generating elements is thermally connected to the line formation layer.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a phase shifter according to the present disclosure;

FIG. 2 is a conceptual diagram illustrating one portion of an internal configuration included in a variable phase shift circuit according to the present disclosure;

FIG. 3 is a conceptual diagram illustrating one portion of an internal configuration included in the variable phase shift circuit according to the present disclosure;

FIG. 4 is a conceptual diagram illustrating an example of a circuit configuration of a heat generation drive circuit according to the present disclosure;

FIG. 5 is a conceptual diagram illustrating another example related to a portion of the internal configuration included in the variable phase shift circuit according to the present disclosure;

FIG. 6 is a conceptual diagram illustrating another example related to a portion of the internal configuration included in the variable phase shift circuit according to the present disclosure;

FIG. 7 is a block diagram illustrating an example of a configuration of an antenna device including a phase shifter according to the present disclosure;

FIG. 8 is a conceptual diagram for explaining an example of the line formation control of the variable phase shift circuit according to the present disclosure;

FIG. 9 is a conceptual diagram for explaining an example of the line formation control of the variable phase shift circuit according to the present disclosure;

FIG. 10 is a conceptual diagram for explaining an example of the line formation control of the variable phase shift circuit according to the present disclosure;

FIG. 11 is a conceptual diagram for explaining an example of the line formation control of the variable phase shift circuit according to the present disclosure;

FIG. 12 is a conceptual diagram for explaining an example of the line formation control of the variable phase shift circuit according to the present disclosure;

FIG. 13 is a conceptual diagram for explaining an example of the line formation control of the variable phase shift circuit according to the present disclosure;

FIG. 14 is an example of a table used to select a conductor pattern formed on the variable phase shift circuit according to the present disclosure;

FIG. 15 is a conceptual diagram illustrating an example of a configuration of a phase shifter according to the present disclosure;

FIG. 16 is a conceptual diagram illustrating an example of a configuration of a phase shifter according to the present disclosure;

FIG. 17 is a conceptual diagram illustrating an example of a configuration of a phase shifter according to the present disclosure;

FIG. 18 is a conceptual diagram illustrating an example of a configuration of a phase shifter according to the present disclosure;

FIG. 19 is a conceptual diagram illustrating an example of a configuration of a phase shifter according to the present disclosure;

FIG. 20 is a conceptual diagram illustrating an example of a configuration of a phase shifter according to the present disclosure;

FIG. 21 is a conceptual diagram illustrating an example of a configuration of a phase shifter according to the present disclosure;

FIG. 22 is a conceptual diagram illustrating an example of a configuration of an antenna device according to the present disclosure;

FIG. 23 is a conceptual diagram illustrating an example of a configuration of the antenna device according to the present disclosure;

FIG. 24 is a conceptual diagram illustrating an example of a matrix circuit formed on an upper surface of a substrate according to the present disclosure;

FIG. 25 is a conceptual diagram illustrating an example of a configuration of the antenna device according to the present disclosure;

FIG. 26 is a block diagram illustrating an example of a functional configuration of the antenna device according to the present disclosure;

FIG. 27 is a conceptual diagram illustrating an example of a configuration of a phase shifter according to the present disclosure; and

FIG. 28 is a block diagram illustrating an example of a hardware configuration that executes control according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a phase shifter according to a first example embodiment will be described with reference to the drawings. For example, the phase shifter of the present example embodiment is mounted on an antenna device including a patch antenna, which is a type of planar antenna. The phase shifter of the present example embodiment can be applied to transmission of a transmission target radio wave and reception of a reception target radio wave arriving from the outside. For example, the phase shifter of the present example embodiment can be applied to an antenna device used for transmission and reception of a transmission/reception target signal in a high frequency band used in mobile communication after the fifth generation mobile communication. Hereinafter, the electrical length of the transmission/reception target signal on a substrate is denoted by λ (λis a real number). Hereinafter, an example in which the phase shifter of the present example embodiment is used to transmit a transmission target signal will be described. In the following description, the reception of the reception target signal will not be described.

### Configuration

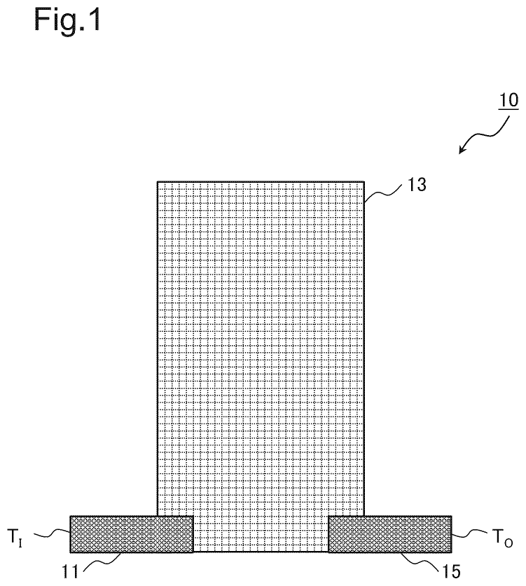

FIG. 1 is a conceptual diagram illustrating an example of a configuration of a phase shifter according to the present disclosure. The phase shifter 10 includes an input line 11, a variable phase shift circuit 13, and an output line 15.

The input line 11 is connected to the variable phase shift circuit 13. A transmission target signal is input to an input terminal T_{I} of the input line 11. The transmission target signal input to the input line 11 is output to the variable phase shift circuit 13. The input line 11 is a line made of a conductor. For example, the material of the input line 11 is metal (including alloy) such as copper, aluminum, and chromium.

The variable phase shift circuit 13 is a stub having a line formation layer made of vanadium dioxide VO₂. A plurality of heat generating elements arrayed in a two-dimensional array form are in thermal contact with the line formation layer. The variable phase shift circuit 13 is a phase shift circuit in which a line length using a phase transition between an insulating phase and a metal phase of vanadium dioxide VO₂ is variable. Vanadium dioxide VO₂ contained in the line formation layer is an insulating layer at a temperature lower than the phase transition temperature T. When the phase transition temperature T is exceeded, the vanadium dioxide VO₂ contained in the insulating phase line formation layer undergoes phase transition from the insulating phase to the metal phase. The line length of the variable phase shift circuit 13 changes according to the state of phase transition of the vanadium dioxide VO₂ constituting the variable phase shift circuit 13. A portion of the line formation layer heated to a temperature exceeding the phase transition temperature of the vanadium dioxide VO₂ by heat generation of the heat generating element undergoes phase transition to the metal phase. The conductor pattern formed in the line formation layer can be controlled depending on the selection status of the heat generating element. The conductor pattern formed in the line formation layer is a line through which the phase shift target signal propagates.

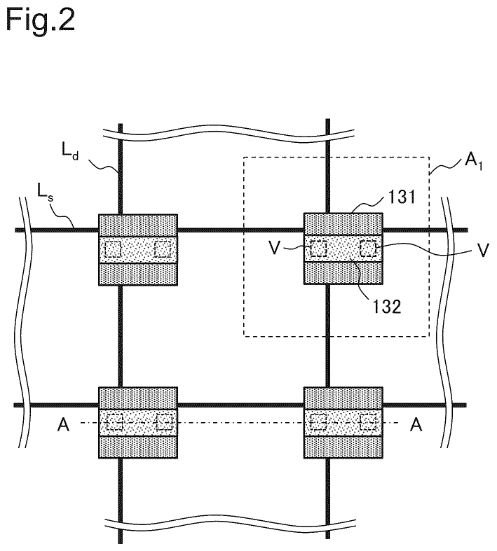

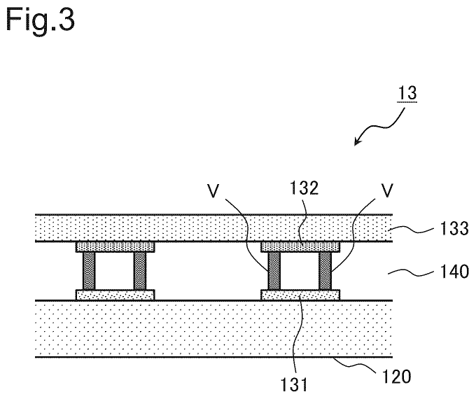

FIGS. 2 and 3 are conceptual diagrams illustrating one portion of an internal configuration included in the variable phase shift circuit according to the present disclosure. FIG. 2 illustrates a plan view of an internal configuration of a variable phase shift circuit in a state where a line formation layer is omitted. FIG. 3 illustrates a cross-sectional view taken along cutting line A-A in FIG. 2. A variable phase shift circuit 13 includes a plurality of heat generation drive circuits 131 and a plurality of heat generating elements 132. The plurality of heat generation drive circuits 131 and the plurality of heat generating elements 132 are arranged in a two-dimensional array form. One heat generation drive circuit 131 is associated with one heat generating element 132. In the example of FIGS. 2 to 3, the heat generating element 132 is disposed above the heat generation drive circuit 131. The line formation layer 133 is disposed above the heat generation drive circuit 131 and the heat generating element 132. In FIG. 2, the inner side of a range A₁ surrounded by a broken-line frame indicates an indication of a region to be heated by one heat generating element 132. The heat generation drive circuit 131 and the heat generating element 132 are electrically connected by a via V. The plurality of heat generation drive circuits 131 configuring the same row are connected to a common data line L_{d} (power source line). The plurality of heat generation drive circuits 131 configuring the same column are connected to a common selection line Lₛ. The data line L_{d} and the selection line Lₛ are used to select the heat generation drive circuit 131 associated with the heat generating element 132 used to form a conductor pattern.

The variable phase shift circuit 13 is formed on the substrate 120. For example, the substrate 120 is a plate-like member having an insulating property such as glass or epoxy resin. On an upper surface of substrate 120, a matrix circuit of thin film transistors (TFTs) including a plurality of heat generation drive circuits 131 is formed. The data line L_{d} and the selection line Ls constitute a matrix circuit. The line formation layer 133 is formed above the plurality of heat generating elements 132. The substrate 120 and a line formation layer 133 are insulated from each other by the insulating layer 140. The side end portion of the line formation layer 133 is connected to an input line 11 and an output line 15 by a conductive structure (not illustrated).

The plurality of heat generation drive circuits 131 are formed on the upper surface of the substrate 120. The plurality of heat generation drive circuits 131 are formed in a two-dimensional array form in plan view of the upper surface of the substrate 120. The plurality of heat generation drive circuits 131 are isolated by the insulating layer 140. Each of the plurality of heat generation drive circuits 131 is associated with one heat generating element 132. Each of the plurality of heat generation drive circuits 131 is used for temperature control of the associated heat generating element 132.

Each of the plurality of heat generating elements 132 is associated with one heat generation drive circuit 131. The heat generating element 132 is disposed above the associated heat generation drive circuit 131. The heat generating element 132 may be disposed at a position not above the associated heat generation drive circuit 131. The heat generating element 132 is electrically connected to the associated heat generation drive circuit 131 via the via V. The line formation layer 133 is formed on the upper surfaces of the plurality of heat generating elements 132. The plurality of heat generating elements 132 are isolated by the insulating layer 140. The plurality of heat generating elements 132 may be isolated by a gap formed in the insulating layer 140. The heat generating element 132 is used to heat the line formation layer 133 on the upper side. For example, the heat generating element 132 is achieved by an alloy having nickel Ni or chromium Cr as a main component. The heat generating element 132 may be achieved by an alloy having chromium Cr, iron Fe, and aluminum Al as main components. The material of the heat generating element 132 is not particularly limited. When current is supplied, the temperature of the heat generating element 132 rises. For example, supply of current to the heat generating element 132 can be controlled using a thin film transistor (TFT). The heat of the heat generating element 132 is transferred to the line formation layer 133.

The line formation layer 133 is disposed above the plurality of heat generating elements 132. The lower surface of the line formation layer 133 and the upper surfaces of the plurality of heat generating elements 132 are thermally connected. The lower surface of the line formation layer 133 and the upper surfaces of the plurality of heat generating elements 132 are preferably in contact with each other. As long as the heat of the heat generating element 132 can be transferred to the line formation layer 133 and the phase transition can be controlled, another layer may be interposed between the lower surface of the line formation layer 133 and the upper surfaces of the plurality of heat generating elements 132. The line formation layer 133 is partially heated by the heat generating element 132 at the position on the lower side generating heat.

The line formation layer 133 contains vanadium dioxide VO₂. In the line formation layer 133, a line having electrical conductivity is formed by phase transition of an insulating phase-metal phase of vanadium dioxide VO₂. Vanadium dioxide VO₂ contained in the line formation layer 133 has a composition that undergoes a phase transition from an insulating phase to a metal phase at a phase transition temperature T. At a temperature lower than the phase transition temperature T, the vanadium dioxide VO₂ is an insulating phase. At a temperature lower than the phase transition temperature T, electricity does not flow through the vanadium dioxide VO₂. At a temperature higher than the phase transition temperature T, the vanadium dioxide VO₂ is a metal phase. At a temperature higher than the phase transition temperature T, electricity flows through the vanadium dioxide VO₂. The phase transition of vanadium dioxide VO₂ exhibits hysteresis in temperature rise and temperature fall. Therefore, the phase transition of the insulating phase-metal phase of vanadium dioxide VO₂ is adjusted in a temperature range including the phase transition temperature T.

For example, the line formation layer 133 may have a line formation layer containing vanadium dioxide VO₂ to which no additive element is added. For example, an additive element may be added to vanadium dioxide VO₂ contained in the line formation layer 133. For example, an additive element for lowering the phase transition temperature may be added to vanadium dioxide VO₂ contained in the line formation layer 133. When an additive element such as tungsten W, magnesium Mg, iron Fe, molybdenum Mo, fluorine F, or niobium Nb is added, the phase transition temperature of vanadium dioxide VO₂ lowers.

The insulating layer 140 is formed on the upper surface of the substrate 120. The insulating layer 140 covers the sides of the heat generation drive circuit 131 and the heat generating element 132. The line formation layer 133 is disposed above the insulating layer 140. For example, the insulating layer 140 is made of a general interlayer insulating material. For example, the insulating layer 140 is made of an inorganic material such as silicon dioxide. The material of the insulating layer 140 may be an organic material.

The output line 15 is connected to the variable phase shift circuit 13. The output line 15 receives a transmission target signal phase shifted by the variable phase shift circuit 13. The transmission target signal input to the output line 15 is output from the output terminal T_{O}. The transmission target signal output from the output terminal T_{O} is sent via a patch antenna (not illustrated). The output line 15 is a line made of a conductor. For example, the material of the output line 15 is metal (including alloy) such as copper, aluminum, and chromium.

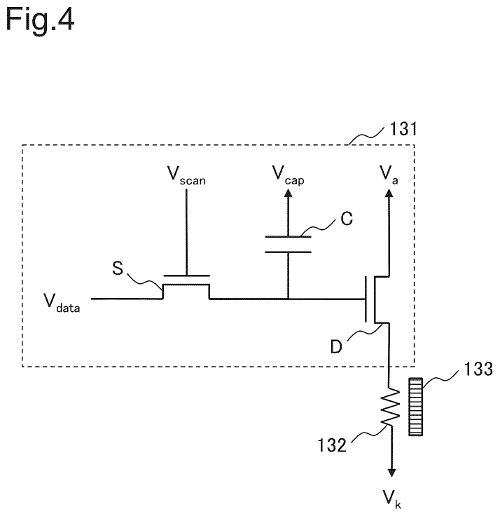

FIG. 4 is a conceptual diagram illustrating an example of a circuit configuration of a heat generation drive circuit according to the present disclosure. The heat generation drive circuit 131 includes a transistor S, a transistor D, and a capacitor C. FIG. 4 illustrates an example in which the heat generating element 132 is achieved by a resistance element. Hereinafter, a connection relationship among the transistor S, the transistor D, the capacitor C, and the heat generating element 132 will be described. In the following description, directions in the plane of drawing of FIG. 4 are shown in parentheses. FIG. 4 illustrates an example of the circuit configuration of the heat generation drive circuit according to the present disclosure, and does not limit the circuit configuration of the heat generation drive circuit.

The transistor S is used to select the heat generating element 132. A first end (left side) of the diffusion layer of the transistor S is connected to a supply source of the voltage V_{data}. The second end (right side) of the diffusion layer of the transistor S is connected to the first electrode (lower side) of the capacitor C and the gate (left side) of the transistor D. The gate (upper side) of the transistor S is connected to a supply source of the voltage V_{scan}.

The capacitor C is used to control the voltage applied to the gate of the transistor D. The first electrode (lower side) of the capacitor C is connected to the second end (right side) of the diffusion layer of the transistor S and the gate (left side) of the transistor D. The second electrode (upper side) of the capacitor C is connected to a supply source of the voltage V_{cap}. A voltage V_{cap} is applied to the second electrode (upper side) of the capacitor C.

The transistor D is used to control the voltage to be supplied to the heat generating element 132. A first end (upper side) of the diffusion layer of the transistor D is connected to a supply source of the voltage Vₐ. The voltage Vₐ is applied to the first end (upper side) of the diffusion layer of the transistor D. The second end (lower side) of the diffusion layer of the transistor D is connected to the first electrode (lower side) of the heat generating element 132. The gate (left side) of the transistor D is connected to the second end (right side) of the diffusion layer of the transistor S and the first end (lower side) of the capacitor C.

The first end (upper side) of the heat generating element 132 is connected to the second end (lower side) of the diffusion layer of the transistor D. The second end (lower side) of the heat generating element 132 is connected to a supply source of the voltage Vₖ. The voltage Vₖ is applied to the second end (lower side) of the heat generating element 132. When the transistor S transitions to an ON state by the application of the voltage V_{scan}, a voltage that is a difference between the voltage V_{data} and the voltage V_{cap} is applied to the capacitor C. When charging of the capacitor C is completed, the transistor S transitions to an OFF state. After the transistor S transitions to the OFF state, the capacitor C holds the voltage, and the transistor D continues to maintain the ON state according to the potential. In an ON state of the transistor D, a current corresponding to a voltage corresponding to a potential difference between the voltage Vₐ and the voltage Vₖ and a resistance value of the heat generating element 132 flows, and the heat generating element 132 generates heat. The heat generated in the heat generating element 132 is transferred to the line formation layer 133 in thermal contact with the heat generating element 132.

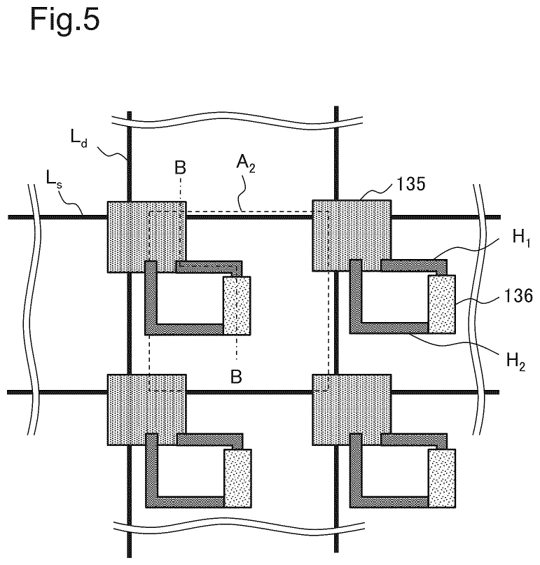

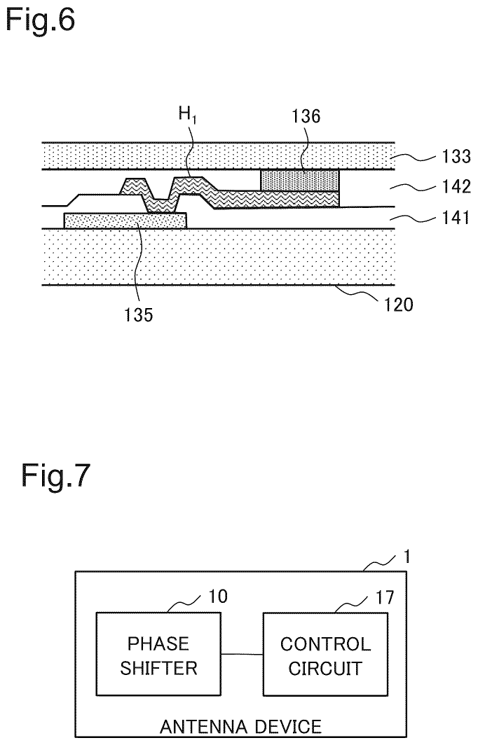

FIGS. 5 and 6 are conceptual diagrams illustrating another example related to a portion of the internal configuration included in the variable phase shift circuit according to the present disclosure. FIGS. 5 to 6 are examples in which the heat generating element is disposed obliquely above the heat generation drive circuit. FIG. 5 illustrates a plan view of an internal configuration of a variable phase shift circuit in a state where the line formation layer is omitted. FIG. 6 illustrates a cross-sectional view taken along a cutting line B-B in FIG. 5. In the example of FIGS. 5 to 6, the variable phase shift circuit includes a plurality of heat generation drive circuits 135 and a plurality of heat generating elements 136. The heat generation drive circuit 135 has a configuration similar to that of the heat generation drive circuit 131. The heat generating element 136 has a configuration similar to that of the heat generating element 132. The plurality of heat generation drive circuits 135 and the plurality of heat generating elements 136 are arrayed in a two-dimensional array form. One heat generation drive circuit 135 is associated with one heat generating element 136. The substrate 120 and the line formation layer 133 are insulated from each other by the insulating layer 141 and the insulating layer 142.

In the example of FIGS. 5 to 6, the heat generating element 136 is disposed obliquely above the heat generation drive circuit 135. In FIG. 5, the inner side of a range A₂ surrounded by a broken-line frame indicates an indication of a region to be heated by one heat generating element 136. The heat generation drive circuit 135 and the heat generating element 136 are electrically connected by a contact electrode H₁ and a contact electrode H₂. The plurality of heat generation drive circuits 135 configuring the same row are connected to a common data line L_{d} (power source line). The plurality of heat generation drive circuits 135 configuring the same column are connected to a common selection line Lₛ. The data line La and the selection line Lₛ are used to select the heat generation drive circuit 131 associated with the heat generating element 136 used to form a conductor pattern.

FIG. 7 is a block diagram illustrating an example of a configuration of an antenna device including a phase shifter according to the present disclosure. The antenna device 1 includes a phase shifter 10 and a control circuit 17. The control circuit 17 is a circuit for controlling the phase shifter 10. For example, the control circuit 17 is achieved by a microcomputer including a processor and a memory. The control circuit 17 controls the heat generation drive circuit 131 included in the variable phase shift circuit 13 of the phase shifter 10 to control the conductor pattern of the line formation layer 133. The capacitance of the variable phase shift circuit 13 is adjusted according to the control of the control circuit 17. The control circuit 17 may be configured as a component of the phase shifter 10.

### Line Formation Control

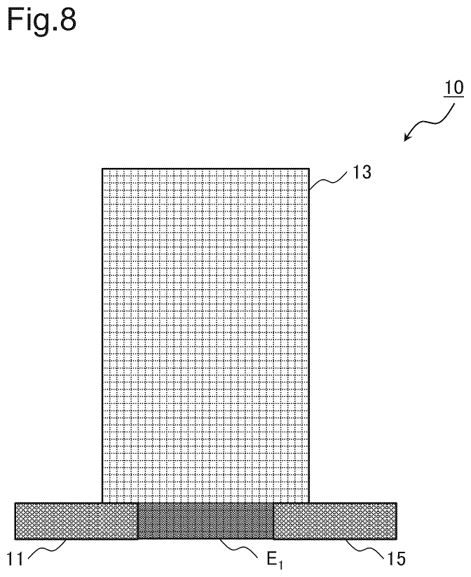

Next, line formation control in the variable phase shift circuit 13 will be described with reference to the drawings. FIGS. 8 to 13 are conceptual diagrams for explaining an example of the line formation control of the variable phase shift circuit according to the present disclosure. FIGS. 8 to 13 illustrate an example in which a conductive portion (line) is formed in a variable phase shift circuit according to the present disclosure. FIGS. 8 to 13 are plan views of the variable phase shift circuit viewed from an upper viewpoint. The extended line E is a conductive portion formed in the line formation layer 133. The extended line E is indicated by hatching different from that of the non-conductive portion. The extended line E is formed with the output end of the input line 11 as a start point and the input end of the output line 15 as an end point. The extended line E electrically connects the input line 11 and the output line 15. In a state where the extended line E is not formed between the input line 11 and the output line 15, the phase shifter 10 including the variable phase shift circuit 13 does not function. That is, the patch antenna (not illustrated) in which the phase shifter in which the extended line E is not formed is configured is set to the OFF state.

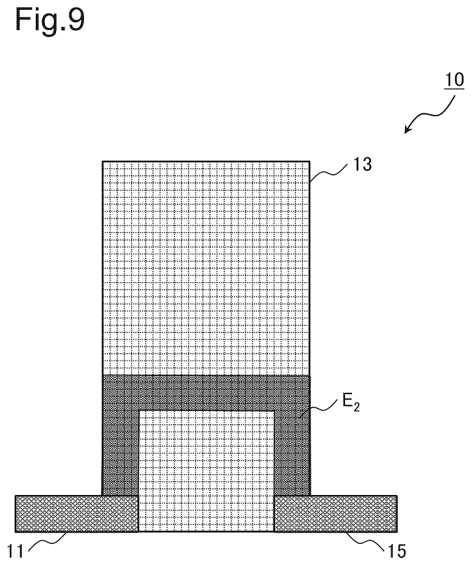

FIG. 8 illustrates an example in which a linear extended line is formed from the output end of the input line toward the input end of the output line. FIG. 8 is an example of an extended line E₁ formed the shortest between the input line 11 and the output line 15. The extended line E₁ is a line to become a reference of the extended lines illustrated in FIGS. 9 to 13.

FIG. 9 illustrates an example in which an extended line bent from the output end of the input line toward the input end of the output line is formed. FIG. 9 illustrates an example in which the extended line is folded back once in the longitudinal direction (up-down direction in the plane of drawing) of the variable phase shift circuit 13. In the example of FIG. 9, the extended line E extending from the upper part of the output end of the input line 11 is extended upward by a half of a desired line length along the left side of the variable phase shift circuit 13. The extended line E₂ extending upward is bent and extended rightward. The extended line E₂ reaching the right end of the variable phase shift circuit 13 is extended downward by a half of a desired line length along the right side of the variable phase shift circuit 13. By being extended in this way, a phase shift amount of a desired line length is set in the variable phase shift circuit 13.

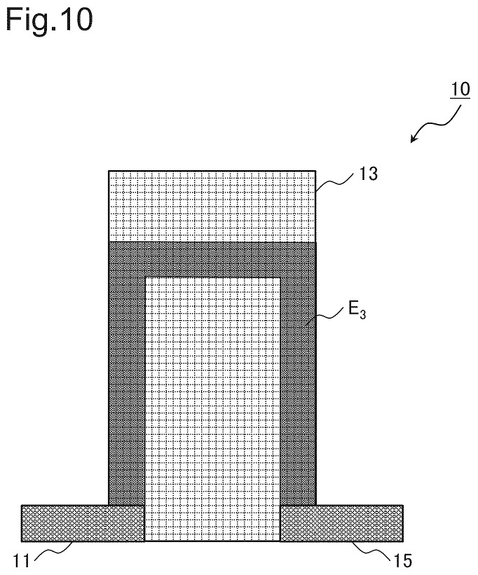

FIG. 10 illustrates an example in which an extended line bent from the output end of the input line toward the input end of the output line is formed. FIG. 10 illustrates an example in which the extended line is folded back once in the longitudinal direction (up-down direction in the plane of drawing) of the variable phase shift circuit 13. In the example of FIG. 10, the extended line E₃ extending from the upper part of the output end of the input line 11 is extended upward by a half of a desired line length along the left side of the variable phase shift circuit 13. The extended line E₃ extending upward is bent and extended rightward. The extended line E₃ reaching the right end of the variable phase shift circuit 13 is extended downward by a half of a desired line length along the right side of the variable phase shift circuit 13. By being extended in this way, a phase shift amount of a desired line length is set in the variable phase shift circuit 13. The line length is longer in the extended line E₃ (FIG. 10) than in the extended line E₂ (FIG. 9). Therefore, the phase shift amount is larger in the extended line E₃ (FIG. 10) than in the extended line E₂ (FIG. 9).

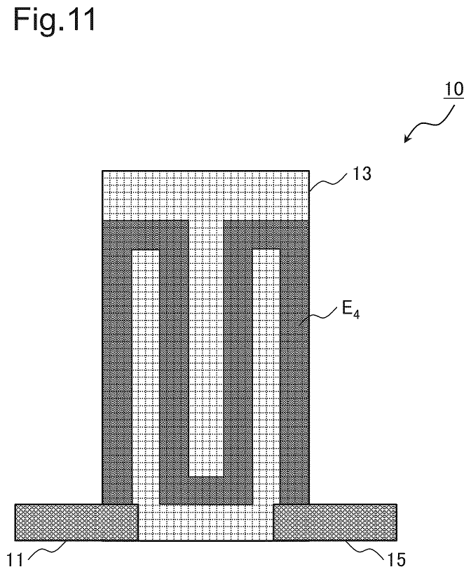

FIG. 11 illustrates an example in which an extended line bent from an output end of an input line toward an input end of an output line is formed. FIG. 11 illustrates an example in which the extended line is folded back three times in the longitudinal direction (up-down direction in the plane of drawing) of the variable phase shift circuit 13. In the example of FIG. 11, the extended line E₄ extending from the upper part of the output end of the input line 11 is extended upward by ¼ of a desired line length along the left side of the variable phase shift circuit 13. The extended line E₄ extended upward by ¼ of the desired line length is extended to a position in front of the center of the variable phase shift circuit 13 and is extended downward by ¼ of the desired line length. The extended line E₄ extended downward by ¼ of the desired line length is extended to a position beyond the center of the variable phase shift circuit 13 and is extended upward by ¼ of the desired line length. The extended line E₄ extended upward by ¼ of the desired line length is bent and extended rightward. The extended line E₄ reaching the right end of the variable phase shift circuit 13 is extended downward by ¼ of a desired line length along the right side of the variable phase shift circuit 13. By being extended in this way, a phase shift amount of a desired line length is set in the variable phase shift circuit 13. The line length is longer in the extended line E₄ (FIG. 11) than in the extended line E₃ (FIG. 10). Therefore, the phase shift amount is larger in the extended line E₄ (FIG. 11) than in the extended line E₃ (FIG. 10).

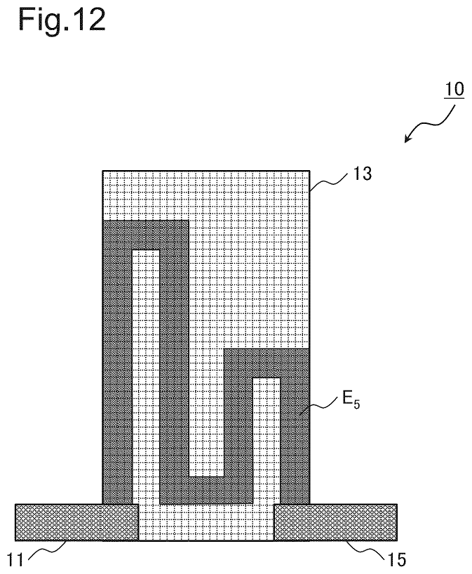

FIG. 12 illustrates an example in which an extended line bent from an output end of an input line toward an input end of an output line is formed. FIG. 12 illustrates an example in which the extended line is folded back three times in the longitudinal direction (up-down direction in the plane of drawing) of the variable phase shift circuit 13. FIG. 12 is an example in which the two fold-back patterns in the example of FIG. 11 are asymmetric. For example, the extended line E₅ extending from the upper part of the output end of the input line 11 is extended upward by 2/6 (⅓) of the desired line length along the left side of the variable phase shift circuit 13. The extended line E₅ extended upward by 2/6 (⅓) of the desired line length is extended to a position in front of the center of the variable phase shift circuit 13, and is extended downward by 2/6 (⅓) of the desired line length. The extended line E₅ extended downward by 2/6 (⅓) of the desired line length is extended to a position beyond the center of the variable phase shift circuit 13 and is extended upward by ⅙ of the desired line length. The extended line E₅ extended upward by ⅙ of the desired line length is bent and extended rightward. The extended line E₅ that has reached the right end of the variable phase shift circuit 13 is extended downward by ⅙ of a desired line length along the right side of the variable phase shift circuit 13. By being extended in this way, a phase shift amount of a desired line length is set in the variable phase shift circuit 13. If a plurality of lines having different fold-back positions are set as in the example of FIG. 12, the line length of the extended line can be finely adjusted.

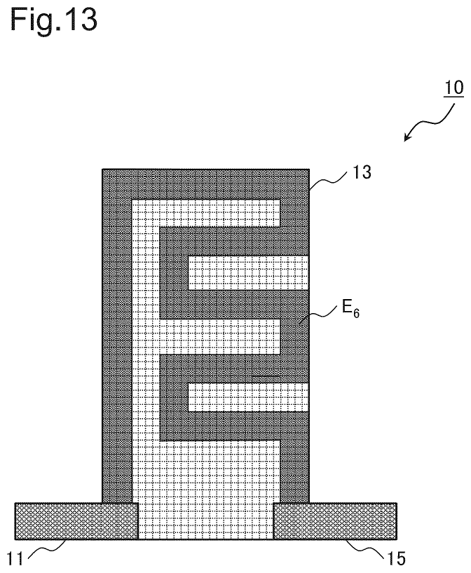

FIG. 13 illustrates an example in which an extended line bent from an output end of an input line toward an input end of an output line is formed. FIG. 12 illustrates an example in which the extended line is folded back once in the longitudinal direction (up-down direction in the plane of drawing) of the variable phase shift circuit 13 and folded back four times in the short direction (left-right direction in the plane of drawing). FIG. 13 illustrates an example in which an extended line of a conductor pattern having an optional shape is set. For example, the extended line E₆ extending from the upper part of the output end of the input line 11 is extended upward along the left side of the variable phase shift circuit 13. The extended line E₆ extended upward is bent and extended rightward. The extended line E₆ that has reached the right end of the variable phase shift circuit 13 is extended downward while being repeatedly bent toward the right and the left. By being extended in this way, a phase shift amount of a desired line length is set in the variable phase shift circuit 13. The line length of the extended line can be finely fine adjusted by setting a line of a conductor pattern having an optional shape as in the example of FIG. 13.

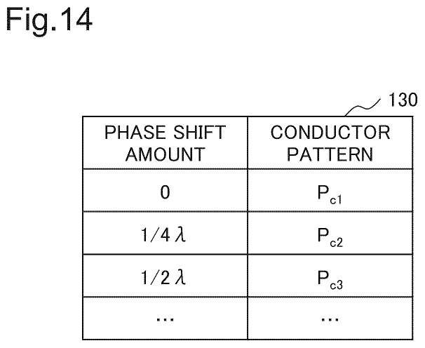

FIG. 14 is an example of a table (phase shift table 130) used to select a conductor pattern of an extended line formed in a variable phase shift circuit according to the present disclosure. The phase shift table 130 stores a conductor pattern P_{c} related to a desired phase shift amount. The conductor pattern P_{c} is associated with an address indicating a position of the heat generating element 132 caused to generate heat for forming the conductor pattern P_{c}. The conductor pattern P_{c1} is associated with the phase shift amount 0. The conductor pattern P_{c2} is associated with the phase shift amount ¼λ. The conductor pattern P_{c3} is associated with the phase shift amount ½λ. For example, a desired phase shift amount is set via an input device (not illustrated). The control circuit 17 selects the heat generation drive circuit 131 to be used for forming the conductor pattern P_{c} related to the set desired phase shift amount. As a result, a desired phase shift amount is set in the variable phase shift circuit 13.

### Modified Example

Next, a modified example of the phase shifter according to the present disclosure will be described with reference to the drawings. Variations of the variable phase shift circuit included in the phase shifter will be described below.

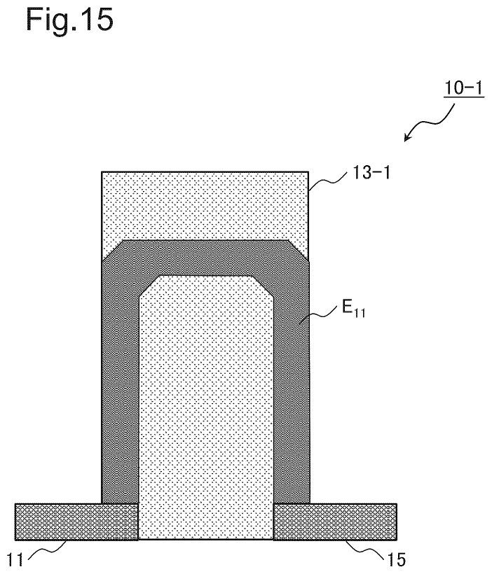

FIG. 15 is a conceptual diagram illustrating an example of a configuration of a phase shifter according to a first modified example of the present disclosure. FIG. 15 is a plan view of a variable phase shift circuit viewed from an upper viewpoint. An extended line E₁₁ is formed in the variable phase shift circuit 13-1 included in the phase shifter 10-1 of the present modified example. The extended line E₁₁ is bent from the output end of the input line toward the input end of the output line. The extended line E₁₁ is folded back once in the longitudinal direction (up-down direction in the plane of drawing) of the variable phase shift circuit 13. The bent portion of the extended line E₁₁ is chamfered and gradual. According to the present modified example, since the bent portion of the extended line E₁₁ is chamfered, signal loss at the bent portion is reduced.

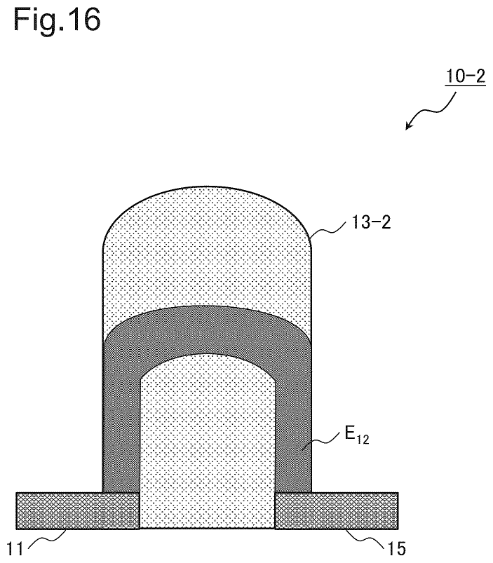

FIG. 16 is a conceptual diagram illustrating an example of a configuration of a phase shifter according to a second modified example of the present disclosure. FIG. 16 is a plan view of a variable phase shift circuit viewed from an upper viewpoint. The variable phase shift circuit 13-2 included in the phase shifter 10-2 of the present modified example has an arcuate upper part. An extended line E₁₂ is formed in the variable phase shift circuit 13-2. The extended line E₁₂ is bent from the output end of the input line toward the input end of the output line. The extended line E₁₂ is folded back once in the longitudinal direction (up-down direction in the plane of drawing) of the variable phase shift circuit 13. The upper part of the extended line E₁₂ is formed in an arc shape following the shape of the upper part of the variable phase shift circuit 13-2. The heat generating elements 132 arranged in the region where the extended line E₁₂ forms an arc are arranged in an arc shape. The heat generating element 132 disposed in this region may be configured in a shape corresponding to an arc. According to the present modified example, since the upper part of the extended line E₁₂ is formed in an arc shape, the loss of the signal at the fold-back portion is reduced.

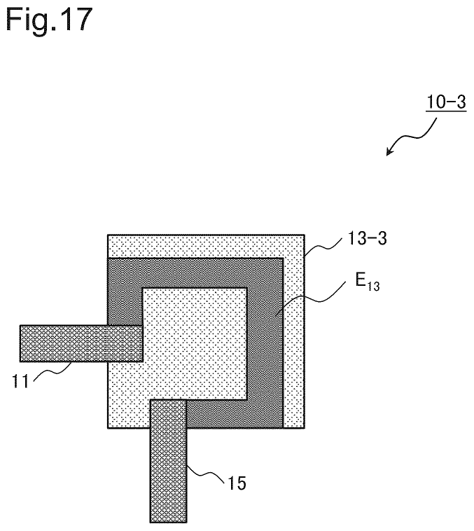

FIG. 17 is a conceptual diagram illustrating an example of a configuration of a phase shifter according to a third modified example of the present disclosure. FIG. 17 is a plan view of a variable phase shift circuit viewed from an upper viewpoint. The variable phase shift circuit 13-3 included in the phase shifter 10-3 of the present modified example has a square shape in plan view. In the present modified example, the extending direction of the input line 11 and the extending direction of the output line 15 are orthogonal to each other. An extended line E₁₃ is formed in the variable phase shift circuit 13-3. The extended line E₁₃ is bent from the output end of the input line toward the input end of the output line. In the example of FIG. 17, an extended line E₁₃ extending from the upper part of the output end of the input line 11 is extended upward along the left side of the variable phase shift circuit 13-3. The extended line E₁₃ extended upward is extended toward the right side and then extended downward. The extended line E₁₃ extended downward is extended leftward along the lower side of the variable phase shift circuit 13-3 and reaches the right side portion of the input end of the output line 15. According to the present modified example, the degree of freedom in arrangement of the input line and the output line is improved.

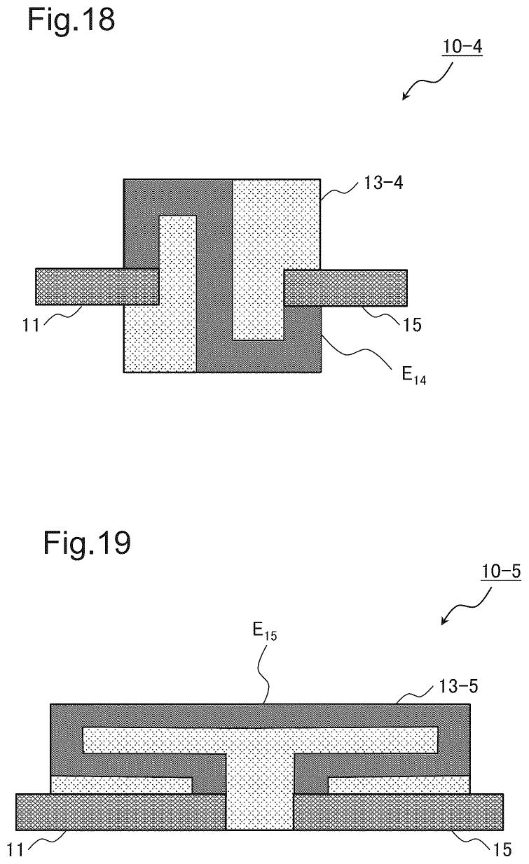

FIG. 18 is a conceptual diagram illustrating an example of a configuration of a phase shifter according to a fourth modified example of the present disclosure. FIG. 18 is a plan view of a variable phase shift circuit viewed from an upper viewpoint. The variable phase shift circuit 13-4 included in the phase shifter 10-4 of the present modified example has a square shape in plan view. In the present modified example, the extending direction of the input line 11 and the extending direction of the output line 15 are the same. The input line 11 and the output line 15 are connected to around the middle of the side of the variable phase shift circuit 13-4. An extended line E₁₄ is formed in the variable phase shift circuit 13-4. The extended line E₁₄ is bent from the output end of the input line toward the input end of the output line. In the example of FIG. 18, an extended line E₁₄ extending from the upper part of the output end of the input line 11 is extended upward along the left side of the variable phase shift circuit 13-4. The extended line E₁₄ extended upward is extended toward the right side and then extended downward from the vicinity of the center. The extended line E₁₄ is extended to the lower side of the variable phase shift circuit 13-4. The extended line E₁₄ that has reached the lower side of the variable phase shift circuit 13-4 is extended rightward along the lower side and extended to the right side of the variable phase shift circuit 13-4. The extended line E₁₄ that has reached the right side of the variable phase shift circuit 13-4 is extended upward along the right side of the variable phase shift circuit 13-4 and reaches the lower part of the output end of the output line 15. According to the present modified example, the degree of freedom in arrangement of the input line, the variable phase shift circuit, and the output line is improved.

FIG. 19 is a conceptual diagram illustrating an example of a configuration of a phase shifter according to a fifth modified example of the present disclosure. FIG. 19 is a plan view of a variable phase shift circuit viewed from an upper viewpoint. The variable phase shift circuit 13-5 included in the phase shifter 10-5 of the present modified example has a rectangular shape having long sides in the left-right direction in plan view. The input line 11 and the output line 15 are arranged along the lower side of the variable phase shift circuit 13-5. An extended line E₁₅ is formed in the variable phase shift circuit 13-5. The extended line E₁₅ is bent from the output end of the input line toward the input end of the output line. In the example of FIG. 19, an extended line E₁₅ extending from the upper part of the output end of the input line 11 is extended toward the left side on the way. The extended line E₁₅ that has reached the left side of the variable phase shift circuit 13-5 is extended upward along the left side and extended to the upper side of the variable phase shift circuit 13-5. The extended line E₁₅ that has reached the upper side of the variable phase shift circuit 13-5 is extended rightward along the upper side of the variable phase shift circuit 13-5 and extended to the right side of the variable phase shift circuit 13-5. The extended line E₁₅ that has reached the right side of the variable phase shift circuit 13-5 is extended downward along the right side of the variable phase shift circuit 13-5 and extended toward the right side on the way. The extended line E₁₅ that has reached above the output end of the output line 15 is extended downward and reaches the upper part of the output end of the output line 15. According to the present modified example, the variable phase shift circuit can be formed in a compact shape in the up-down direction.

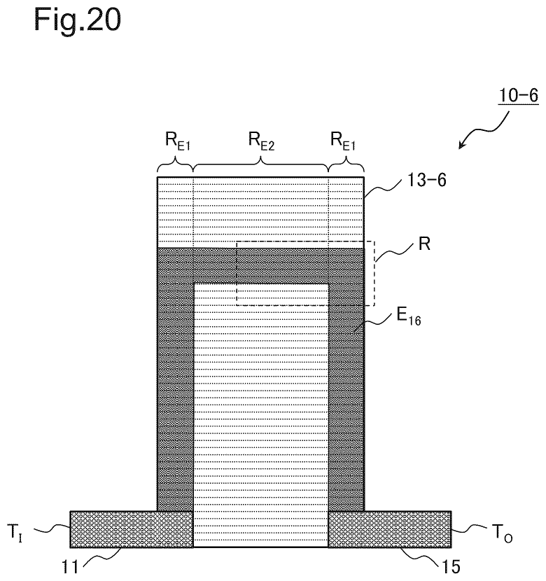

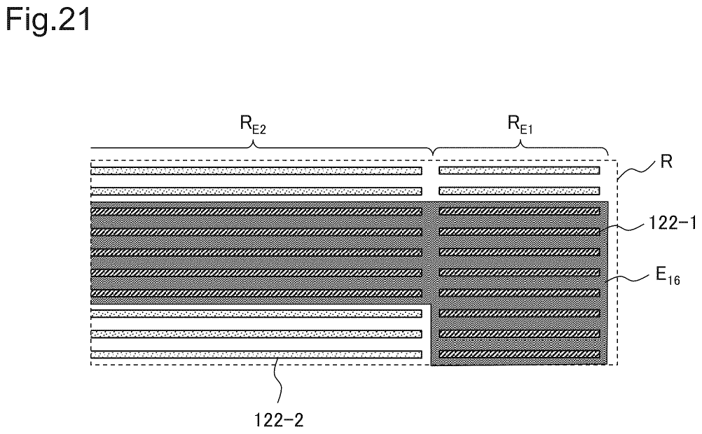

FIGS. 20 to 21 are conceptual diagrams illustrating an example of a configuration of a phase shifter according to a sixth modified example of the present disclosure. FIG. 20 is a plan view of a variable phase shift circuit viewed from an upper viewpoint. FIG. 21 is an enlarged view illustrating a heat generating state of the heat generating element 132 included in a range of a broken-line frame R in FIG. 20. The variable phase shift circuit 13-6 included in the phase shifter 10-6 of the present modified example has a rectangular shape having long sides in the up-down direction in plan view. The variable phase shift circuit 13-6 of the present modified example includes a heat generating element 132-1 and a heat generating element 132-2. The aspect ratio of the heat generating element 132-2 is large as compared with the aspect ratio of the heat generating element 132-1. The heat generating element 132-1 is disposed in a region R_{E1} above the input line 11 and the output line 15. The heat generating element 132-2 is disposed in a region R_{E2} not above the input line 11 and the output line 15. As compared with the heat generating element 132-1, the heating element 132-2 is allocated to the line formation layer 133 of a wider range. The variable phase shift circuit 13-6 of the present modified example is configured by combining the heat generating element 132-1 and the heat generating element 132-2 having different shapes. According to the present modified example, since the number of elements of the heat generating element included in the variable phase shift circuit can be reduced, the yield of the heat generating element is improved.

As described above, the phase shifter according to the present example embodiment includes the input line, the variable phase shift circuit, and the output line. The input line is connected to a signal source of the transmission target signal. The input line is connected to the variable phase shift circuit. The variable phase shift circuit has a line formation layer made of vanadium dioxide. The variable phase shift circuit includes a plurality of heat generating elements and a plurality of heat generation drive circuits. The plurality of heat generating elements are arranged in an array form along one surface of the line formation layer. Each of the plurality of heat generation drive circuits is disposed one by one in association with each of the plurality of heat generating elements. Each of the plurality of heat generating elements is thermally connected to the line formation layer. The output line is connected to the variable phase shift circuit.

The phase shifter of the present example embodiment includes a line formation layer made of vanadium dioxide. By performing temperature control of each of the plurality of heat generating elements, an extended line corresponding to the phase transition of the insulating phase-metal phase of vanadium dioxide is formed in the line formation layer. A continuous phase shift amount can be set in the line formation layer by controlling the line length of the extended line to be formed. According to the phase shifter of the present example embodiment, it is not necessary to provide a plurality of phase shift lines corresponding to the phase shift length, and a compact configuration can be achieved. Therefore, according to the phase shifter of the present example embodiment, it is possible to provide a phase shifter having a compact configuration capable of achieving continuous phase shift change.

In one aspect of the present example embodiment, each of the plurality of heat generation drive circuits causes the heat generating element to generate heat to a temperature exceeding the phase transition temperature of vanadium dioxide contained in the line formation layer according to selection of the heat generating element. According to the present aspect, a desired phase shift amount can be set by selecting a heat generating element according to the phase shift amount.

In one aspect of the present example embodiment, as the vanadium dioxide contained in the line formation layer in contact with the heat generating element that has generated heat exceeds the phase transition temperature and undergoes phase transition to the metal phase, an extended line electrically connecting the input line and the output line is formed in the line formation layer. According to the present aspect, the transmission target signal can be phase-shifted according to the line length of the extended line formed in the line formation layer.

In one aspect of the present example embodiment, an extended line linearly connecting an input line and an output line is formed in the line formation layer. According to the present aspect, the transmission target signal can be transmitted without phase shift.

In one aspect of the present example embodiment, a bent extended line is formed in the line formation layer. According to the present aspect, the transmission target signal can be phase shifted by a desired phase shift amount by adjusting the line length of the bent extended line.

In one aspect of the present example embodiment, an extended line having an optional shape is formed in the line formation layer. According to the present aspect, the transmission target signal can be phase shifted by a desired phase shift amount by adjusting the line length of the extended line in an optional shape.

In one aspect of the present example embodiment, heat generating elements having different shapes are combined. According to the present aspect, by changing the shape of the heat generating element according to the extending direction of the extended line, the number of elements of the heat generating element included in the variable phase shift circuit can be reduced. Therefore, according to the present aspect, since the number of elements of the heat generating element can be reduced, the yield of the heat generating element is improved.

In one aspect of the present example embodiment, any of the plurality of heat generating elements included in the line formation layer is arranged such that the extended line forms an arc. According to the present aspect, by increasing the curvature of the fold-back portion of the extended line, the loss of the transmission target signal at the fold-back portion of the extended line can be reduced.

In one aspect of the present example embodiment, a heat generation drive circuit that causes a heat generating element used for forming an extended line related to a conductor pattern related to a desired phase shift amount to generate heat is selected using a phase shift table in which the conductor pattern related to the phase shift amount is registered. In the line formation layer, an extended line related to the conductor pattern set using the phase shift table is formed. According to the present aspect, a desired phase shift amount can be easily set using the phase shift table.

### Second Example Embodiment

Next, an antenna device according to a second example embodiment will be described with reference to the drawings. A planar antenna of the present example embodiment includes a patch antenna, which is a type of planar antenna. Hereinafter, description of a transmission device for transmitting a radio wave from the planar antenna and a reception device for receiving a radio wave received by the planar antenna will be omitted. For example, the planar antenna of the present example embodiment is used for transmission and reception of electromagnetic waves in a high frequency band expected to be applied to mobile communication of Beyond 5 Generation (B5G) subsequent to 5 Generation (5G). For example, the planar antenna of the present example embodiment is used for transmission and reception of signals of millimeter waves and terahertz waves. The planar antenna of the present example embodiment may be used for transmission and reception of signals other than millimeter waves and terahertz waves.

The antenna device of the present example embodiment includes the phase shifter according to the first example embodiment. For example, the phase shifter is formed using a manufacturing process technology of micro Light Emitting Diode (LED) display. In addition, the planar antenna of the present example embodiment includes a switching element formed using a manufacturing process technology of a thin-film transistor (TFT). The planar antenna of the present example embodiment is manufactured by combining a manufacturing process technology of a micro LED display (micro LED process technology) and a manufacturing process technology of a thin film transistor (TFT process technology). The planar antenna of the present example embodiment may be manufactured using a technology other than the micro LED process technology and the TFT process technology.

### Configuration

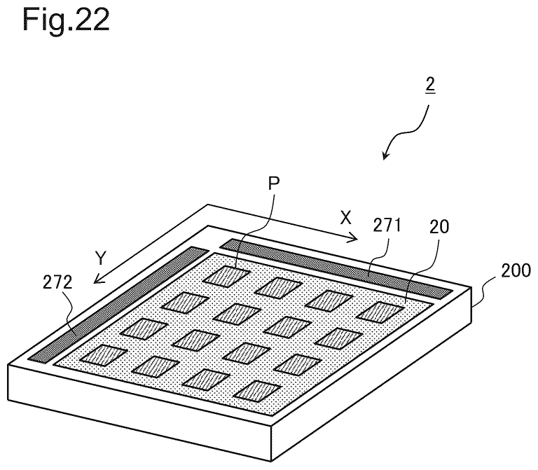

FIG. 22 is a conceptual diagram illustrating an example of a configuration of an antenna device according to the present disclosure. FIG. 22 illustrates an example of an external appearance of the antenna device. The antenna device 2 includes a planar antenna 200. An antenna array 20 is arranged on the upper surface of the planar antenna 200. The antenna array 20 includes a plurality of patch antennas P. The plurality of patch antennas P are arrayed in a two-dimensional array form. In the example of FIG. 22, the plurality of patch antennas P are arrayed along the X direction and the Y direction. The plurality of patch antennas P are phased arrayed. That is, the antenna device 2 functions as a phased array antenna.

A first drive circuit 271 and a second drive circuit 272 are mounted on the antenna device 2. The first drive circuit 271 and the second drive circuit 272 are circuits used to select the patch antenna P to be driven. An address associated to each of the patch antennas P can be selected by driving the first drive circuit 271 and the second drive circuit 272. The first drive circuit 271 and the second drive circuit 272 may be formed on the surface of the planar antenna 200 or may be formed inside the planar antenna 200.

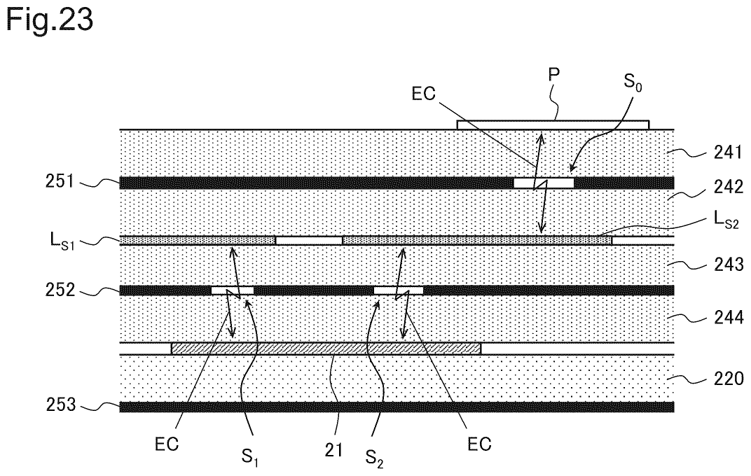

FIG. 23 is a conceptual diagram illustrating an example of a configuration of the antenna device according to the present disclosure. FIG. 23 is a cross-sectional view of the antenna device 2 taken along a cutting line passing through the patch antenna P. The antenna device 2 includes a patch antenna P, an insulating layer, a ground layer, a signal line layer, a substrate 220, and a phase shifter forming layer. The insulating layer includes a first insulating layer 241, a second insulating layer 242, a third insulating layer 243, and a fourth insulating layer 244. The ground layer includes a first ground layer 251, a second ground layer 252, and a third ground layer 253. The signal line layer includes a signal line Lₛ₁ and a signal line Lₛ₂. The phase shifter 21 associated with the patch antenna P is formed in the phase shifter forming layer. FIG. 23 illustrates an example in which the signal line layer and the patch antenna P are formed in different layers. The antenna device according to the present example embodiment may be configured as a coplanar side antenna in which the signal line layer and the patch antenna P are formed in the same layer. The third ground layer 253 may not be provided, and substrate 220 may be disposed at a position of the fourth insulating layer 244.

The antenna array 20 is disposed on the upper surface of the first insulating layer 241. The antenna array 20 includes a plurality of patch antennas P. Although a single patch antenna P is illustrated in FIG. 23, the antenna device 2 includes a plurality of patch antennas P. The plurality of patch antennas P are arranged in a lattice shape along two directions orthogonal to each other. The plurality of patch antennas P are phased arrayed. The patch antenna P is a plate-shaped radiation element. For example, the patch antenna P has a square shape. The shape of the patch antenna P is not limited to a square shape, and may be a circular shape or other shapes.

The patch antenna P is power supplied by an electromagnetic coupling power supplying method. The patch antenna P is electromagnetically coupled to the signal line Lₛ₂ formed below the second insulating layer 242 via the slot S₀. The patch antenna P is excited by electromagnetic coupling between the patch antenna P and the signal line Lₛ₂ via the slot S₀. The impedance can be matched by arranging the open end of the signal line Lₛ₂ at a position away from immediately below the slot S₀ by about ¼ wavelength and adjusting the dimension of the slot S₀. For example, the shape of the slot S₀ is rectangular. For example, the shape of the slot S₀ may be a shape other than a rectangle, such as a dog-bone shape.

The patch antenna P has a structure equivalent to that of a microstrip line whose both ends are opened. The resonance frequency of the patch antenna P is an integral multiple of ½ of a wavelength equivalent to the length of one side of the patch antenna P. The size of the patch antenna P is set according to the wavelength of the transmission target radio wave. Since the patch antenna P is an open type resonator that resonates at a resonance frequency, the Q factor decreases due to radio wave radiation. In order to avoid a decrease in the Q factor due to radio wave radiation and to operate the patch antenna P as a resonator, it is preferable that the dielectric constants of the materials of the insulating layer and the substrate 220 are as high as possible. As the dielectric constants of the materials of the insulating layer and the substrate 220 become higher, the transmission of radio waves can be further suppressed. When the material of the insulating layer and the substrate 220 is a high dielectric, the thickness of the insulating layer and the substrate 220 and the width of the patch antenna P are set to be sufficiently small with respect to the wavelength of the radio wave used in communication. For example, in a case where the material of the insulating layer and the substrate 220 is a low dielectric, a microstrip antenna can be configured by increasing the thickness of the insulating layer and the width of the patch antenna P with respect to the wavelength of the transmission target radio wave to increase the radiation amount.

The patch antenna P is preferably configured such that a signal (radio wave) is easily radiated into space. On the other hand, an internal wiring such as a signal line or a wiring is configured such that a signal is less likely to be radiated. That is, it is better the smaller the dielectric constant required at the periphery of the patch antenna P, and it is better the larger the better the dielectric constant required around the internal wiring. Therefore, it is preferable that different manufacturing processes are applied to the structure around the patch antenna P and the structure around the internal wiring. For example, by applying a method of forming a structure around the patch antenna P by a liquid crystal process and forming a structure around the internal wiring by a thin film process, the structure of the antenna device 2 of the present example embodiment can be achieved.

The first insulating layer 241 forms a surface of the antenna device 2. The first insulating layer 241 is stacked on the upper surface of the first ground layer 251. For example, the material of the first insulating layer 241 is glass, glass epoxy, tetrafluoroethylene, epoxy, or the like. As long as communication radio waves can be transmitted and received, the first insulating layer 241 may be made of a material other than glass, glass epoxy, tetrafluoroethylene, epoxy, or the like.

The first ground layer 251 is stacked on the upper surface of the second insulating layer 242. The first insulating layer 241 is stacked on an upper surface of the first ground layer 251. For example, a material of the first ground layer 251 is metal (including alloy) such as copper, aluminum, and chromium. The potential of the first ground layer 251 is a ground potential. An opening is formed in the first ground layer 251. The opening formed in the first ground layer 251 is referred to as a slot S₀. The slot S₀ is formed below the patch antenna P. The signal line Lₛ₂ is extended immediately below the slot S₀. The signal propagated through the signal line Lₛ₂ is propagated to the patch antenna P by electromagnetic coupling EC between the signal line Lₛ₂ and the patch antenna P.

The second insulating layer 242 is formed above the signal line layer. The first ground layer 251 is formed on an upper surface of the second insulating layer 242. An opening (air gap) may be formed in a portion of the second insulating layer 242 corresponding to a position below the patch antenna P. When the air gap is formed, the dielectric constant between the signal line Lₛ₂ and the patch antenna P lowers. That is, in order to lower the dielectric constant between the signal line Lₛ₂ and the patch antenna P, an air gap merely needs to be formed. For example, the material of the second insulating layer 242 is glass, glass epoxy, tetrafluoroethylene, epoxy, or the like. As long as communication radio waves can be transmitted and received, the second insulating layer 242 may be made of a material other than glass, glass epoxy, tetrafluoroethylene, epoxy, or the like.

The signal line layer is formed on the upper surface of the third insulating layer 243. The second insulating layer 242 is stacked on the upper surface of the signal line layer. The signal line layer includes a signal line Lₛ₁ and a signal line Lₛ₂. The signal line Lₛ₁ (first signal line) is connected to a signal source (not illustrated). The signal sent out from the signal source is propagated to the signal line Lₛ₁. The signal before the phase shift is propagated to the signal line Lₛ₁. The signal line Lₛ₂ (second signal line) is extended in such a way as to pass below the slot So of the first ground layer 251. Capacitances corresponding to the dielectric constants of the first insulating layer 241 and the second insulating layer 242 are formed between the signal line Lₛ₂ and the patch antenna P. In the signal line Lₛ₂, the phase-shifted signal phase-shifted by the phase shifter 21 is propagated to the patch antenna P by the electromagnetic coupling EC via the slot S₀.

The third insulating layer 243 is formed above the second ground layer 252. A signal line layer is formed on the upper surface of the third insulating layer 243. For example, the material of the third insulating layer 243 is glass, glass epoxy, tetrafluoroethylene, epoxy, or the like. As long as communication radio waves can be transmitted and received, the third insulating layer 243 may be made of a material other than glass, glass epoxy, tetrafluoroethylene, epoxy, or the like.

The second ground layer 252 is stacked on the upper surface of the fourth insulating layer 244. The second insulating layer 242 is stacked on an upper surface of the second ground layer 252. For example, a material of the second ground layer 252 is metal (including alloy) such as copper, aluminum, and chromium. The potential of the second ground layer 252 is a ground potential. Two types of openings are formed in second ground layer 252. The two types of openings formed in the second ground layer 252 are referred to as a slot S₁ and a slot S₂. The slot S₁ is formed at a position between the signal line Lₛ₁ and the phase shifter 21. The slot S₂ is formed at a position between the signal line Lₛ₂ and the phase shifter 21. Capacitances corresponding to the dielectric constants of the third insulating layer 243 and the fourth insulating layer 244 are formed between the signal line Lₛ₁ and the phase shifter 21. Similarly, capacitances corresponding to the dielectric constants of the third insulating layer 243 and the fourth insulating layer 244 are formed between the signal line Lₛ₂ and the phase shifter 21. The signal propagated through the signal line Lₛ₁ is propagated to the phase shifter 21 by the electromagnetic coupling EC via the slot S₁. The signal propagated to the phase shifter 21 is phase-shifted by the phase shift amount set in the phase shifter 21 and propagated to the signal line Lₛ₂ by the electromagnetic coupling EC via the slot S₂.

The fourth insulating layer 244 is formed above the phase shifter forming layer. The second ground layer 252 is formed on an upper surface of the fourth insulating layer 244. For example, the material of the fourth insulating layer 244 is glass, glass epoxy, tetrafluoroethylene, epoxy, or the like. As long as communication radio waves can be transmitted and received, the fourth insulating layer 244 may be made of a material other than glass, glass epoxy, tetrafluoroethylene, epoxy, or the like.

In the phase shifter forming layer, the phase shifter 21 is formed for each patch antenna P. The phase shifter forming layer is formed on the upper surface of the substrate 220. The fourth insulating layer 244 is formed on the upper surface of the phase shifter forming layer. Two types of openings (slot S₁, slot S₂) are formed in the second ground layer 252 above phase shifter 21. The signal line Lₛ₁ is disposed above the phase shifter 21 via the slot S₁. The signal line Lₛ₂ is disposed above the phase shifter 21 via the slot S₂. The signal propagated through the signal line Lₛ₁ is propagated to the phase shifter 21 by the electromagnetic coupling EC via the slot S₁. The signal propagated to the phase shifter 21 is phase-shifted by the phase shift amount set in the phase shifter 21 and propagated to the signal line Lₛ₂ by the electromagnetic coupling EC via the slot S₂.

The substrate 220 is disposed below the phase shifter forming layer. On the upper surface of the substrate 220, a matrix circuit, TFT wiring, and a phase shifter 21 are formed. The matrix circuit has a structure in which a plurality of thin-film transistors (TFT) are arranged in a two-dimensional array form. For example, the TFT included in the matrix circuit is formed using a TFT process technology. The TFT wiring includes a plurality of selection lines used to select a phase shifter 21 and a plurality of data lines used to write phase shift data to the phase shifter 21. For example, a material of the substrate 220 is glass, glass epoxy, tetrafluoroethylene, epoxy, or the like. As long as communication radio waves can be transmitted and received, the substrate 220 may be made of a material other than glass, glass epoxy, tetrafluoroethylene, epoxy, or the like.

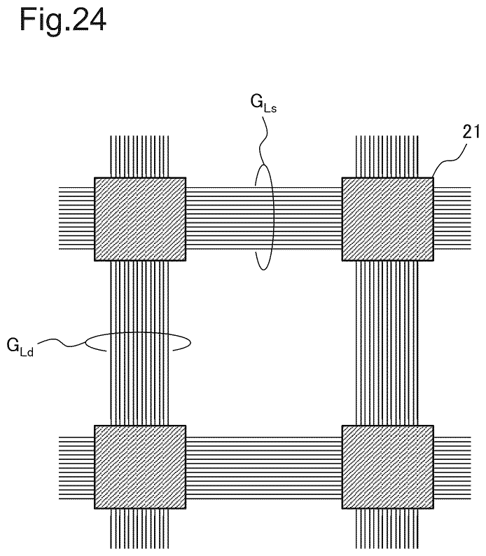

FIG. 24 is a conceptual diagram illustrating an example of a matrix circuit formed on an upper surface of a substrate according to the present disclosure. FIG. 24 is a plan view of a surface on which the matrix circuit is formed as viewed from an upper viewpoint. TFT wiring is formed in the phase shifter forming layer. The TFT wiring includes a selection line group GLs including a plurality of selection lines and a data line group G_{Ld} including a plurality of data lines. Each of the plurality of selection lines included in the selection line group G_{Ls} is used to select the phase shifter 21. Each of the plurality of data lines included in the data line group G_{Ld} is used for propagation of a signal radiated via the phase shifter 21. The TFT wiring may include wiring other than the selection line group G_{Ls} and the data line group G_{Ld}.

The third ground layer 253 is disposed on the lower surface of the substrate 220. The third ground layer 253 is made of a conductor. For example, a material of the third ground layer 253 is metal (including alloy) such as copper, aluminum, and chromium. The potential of the third ground layer 253 is a ground potential. Therefore, a capacitance corresponding to the dielectric constant of the substrate 220 is formed between the phase shifter 21 and the third ground layer 253.

A signal supplied from a signal source (not illustrated) to the signal line Lₛ₁ is propagated to the phase shifter 21 by electromagnetic coupling via the slot S₁. The signal propagated to phase shifter 21 is phase-shifted according to the phase shift amount set in phase shifter 21. The phase-shifted signal is propagated to the signal line Lₛ₂ from the phase shifter 21 by electromagnetic coupling via the slot S₂. The signal phase-shifted by the phase shifter 21 is propagated through the signal line Lₛ₂ and reaches below the patch antenna P. The signal that has reached below the patch antenna P is propagated from the signal line Lₛ₂ to the patch antenna P by electromagnetic coupling via the slot S₀. The signal propagated to the patch antenna P is transmitted as a radio signal from the phased array antenna configured by the plurality of patch antennas P.

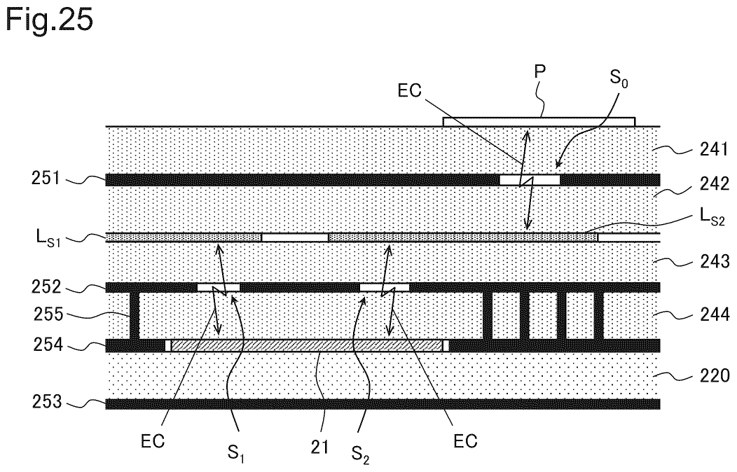

FIG. 25 is a conceptual diagram illustrating an example of a configuration of the antenna device according to the present disclosure. The antenna device illustrated in FIG. 25 is different from the antenna device illustrated in FIG. 23 in that a fourth ground layer is formed on the same layer as the phase shifter forming layer. The fourth ground layer 254 is electrically connected to third ground layer 253 by a plurality of vias 255 penetrating fourth insulating layer 244. The plurality of vias 255 are formed inside the through hole penetrating the fourth insulating layer 244. The fourth ground layer 254 is grounded to the same potential as the third ground layer 253 by the plurality of vias 255. As compared with the configuration of FIG. 23, the configuration of FIG. 25 can be more reliably grounded inside the antenna device.

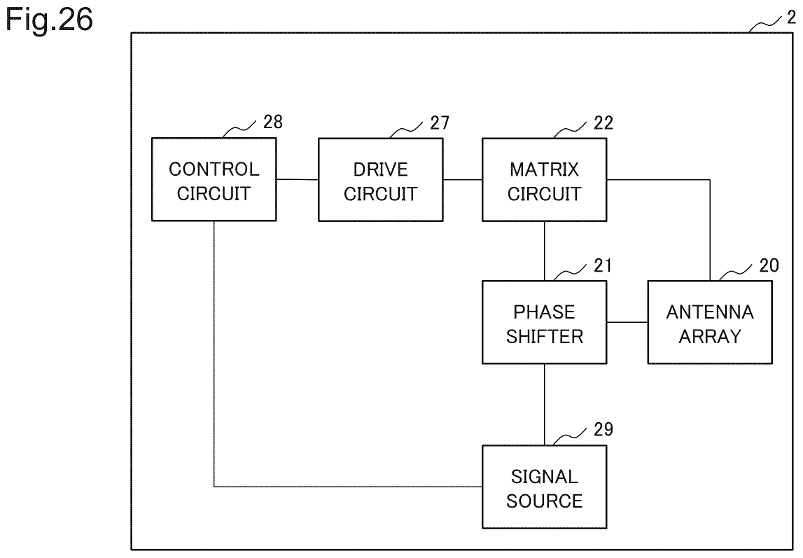

FIG. 26 is a block diagram illustrating an example of a functional configuration of the antenna device according to the present disclosure. The antenna device 2 includes an antenna array 20, a phase shifter 21, a matrix circuit 22, a control circuit 28, and a signal source 29.

The matrix circuit 22 has a configuration in which a plurality of thin-film transistors (TFT) are arrayed in a two-dimensional array form. The matrix circuit 22 is formed using a TFT process technology. Each of the plurality of TFTs included in the matrix circuit 22 is associated with one of the plurality of patch antennas P included in the antenna array 20. For example, the TFT includes a semiconductor layer such as amorphous silicon or polysilicon. Each of the plurality of pixels formed in the matrix circuit 22 is associated with the patch antenna P.

The phase shifter 21 is disposed for each antenna unit. The phase shifter 21 is the phase shifter 10 according to the first example embodiment. The phase shifter 21 is associated with the patch antenna P. The heat generation drive circuit (not illustrated) included in the phase shifter 21 is associated with each of the plurality of pixels formed in the matrix circuit 22. The heat generating element (not illustrated) included in the phase shifter 21 generates heat in accordance with selection of the heat generation drive circuit. An extended line having a line length corresponding to a desired phase shift amount is set in a line formation layer (not illustrated) included in the phase shifter 21. The line length of the extended line is adjusted according to the set conductor pattern. As a result, a phase shift amount corresponding to the line length of the extended line is set in the phase shifter 21.

The drive circuit 27 includes a first drive circuit 271 and a second drive circuit 272. The first drive circuit 271 is a circuit for performing addressing in the X direction. The second drive circuit 272 is a circuit for performing addressing in the Y direction. The drive circuit 27 drives the TFTs included in the matrix circuit 22 under the control of the control circuit 28. The drive circuit 27 individually drives the plurality of TFTs included in the matrix circuit 22.

The control circuit 28 drives the drive circuit 27 according to an external control signal. The control circuit 28 drives the drive circuit 27 by an active matrix drive system. The control circuit 28 drives the first drive circuit 271 and the second drive circuit 272 in conjunction with each other to designate an address associated with each patch antenna P. In addition, the control circuit 28 outputs a control signal from the outside to the signal source 29.

For example, the control circuit 28 is achieved by a microcomputer or a microcontroller. For example, the control circuit 28 includes a Central Processing Unit (CPU), a Random Access Memory (RAM), a Read Only Memory (ROM), a flash memory, and the like. The control circuit 28 executes control and process corresponding to a program stored in advance. The control circuit 28 executes control and process corresponding to a program according to a preset schedule and timing, an external control instruction, and the like. For example, the control circuit 28 controls the antenna array 20 including the plurality of patch antennas P included in the planar antenna 200 to transmit a radio wave having directivity from the antenna array 20. As described above, the antenna array 20 is used as a phased array antenna.

The signal source 29 is connected to the phase shifter 21 via a signal line. In addition, the signal source 29 is connected to the control circuit 28. The signal source 29 transmits a signal to the phase shifter 21 under the control of the control circuit 28. The signal source 29 may be configured to receive a signal from the outside without passing through the control circuit 28.

The signal reaching the signal input unit of the phase shifter 21 through the signal line (not illustrated) connected to the TFT in the ON state is phase-shifted by the phase shift amount set in the phase shifter 21. The phase-shifted signal is propagated from the signal line to the patch antenna P by electromagnetic coupling. The radio wave derived from the signal propagated to the patch antenna P is transmitted from the patch antenna P. Furthermore, the radio wave transmitted from the patch antenna P is based on a signal output from a transmission circuit (not illustrated). The information included in the signal is not particularly limited.

In addition, the radio wave received by the patch antenna P is received according to the capacitance based on the dielectric constant of the dielectric such as the insulating layer or the TFT substrate interposed between the patch antenna P and the signal line. The phase of the received radio wave is phase-shifted by the phase shift amount set in phase shifter 21. The phase-shifted signal is received by a reception circuit (not illustrated) through the signal line. Information included in the signal received by the reception circuit is decoded by a decoder (not illustrated).

As described above, the antenna device according to the present example embodiment includes the phase shifter according to the first example embodiment and the antenna array in which a plurality of patch antennas are arranged in a two-dimensional array form. The phase shifter is arranged in association with each of the plurality of patch antennas.

The antenna device of the present example embodiment includes a phase shifter having a line formation layer made of vanadium dioxide. By performing temperature control of each of the plurality of heat generating elements, an extended line is formed by the phase transition of the insulating phase-metal phase of the vanadium dioxide is formed in the line formation layer. A continuous phase shift amount can be stably set in the line formation layer by controlling the line length of the extended line to be formed. In the plurality of phase shifters included in the antenna device of the present example embodiment, a continuous phase shift change is achieved with a stable phase shift amount. An optional phase shift amount can be set for each of the plurality of patch antennas. Therefore, according to the antenna device of the present example embodiment, a phased array antenna capable of transmitting a radio wave having directivity in an optional direction can be achieved.

### Third Example Embodiment

Next, a phase shifter according to a third example embodiment will be described with reference to the drawings. The phase shifter of the present example embodiment has a configuration obtained by simplifying the phase shifter of the first example embodiment.

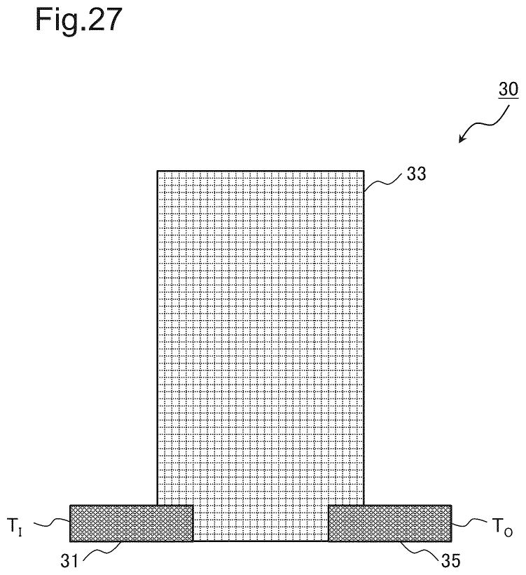

FIG. 27 is a conceptual diagram illustrating an example of a configuration of a phase shifter according to the present disclosure. The phase shifter 30 includes an input line 31, a variable phase shift circuit 33, and an output line 35. The input line 31 is connected to a signal source of the transmission target signal. The variable phase shift circuit 33 is connected to the input line 31. The variable phase shift circuit 33 has a line formation layer made of vanadium dioxide. The variable phase shift circuit 33 includes a plurality of heat generating elements arranged in an array form along one surface of the line formation layer, and a heat generation drive circuit arranged in association with each of the plurality of heat generating elements. Each of the plurality of heat generating elements is thermally connected to the line formation layer. The output line 35 is connected to the variable phase shift circuit 33.

The phase shifter of the present example embodiment includes a line formation layer made of vanadium dioxide. By performing temperature control of each of the plurality of heat generating elements, an extended line corresponding to the phase transition of the insulating phase-metal phase of vanadium dioxide is formed in the line formation layer. A continuous phase shift amount can be set in the line formation layer by controlling the line length of the extended line to be formed. According to the phase shifter of the present example embodiment, it is not necessary to provide a plurality of phase shift lines corresponding to the phase shift length, and a compact configuration can be achieved. Therefore, according to the phase shifter of the present example embodiment, it is possible to provide a phase shifter having a compact configuration capable of achieving continuous phase shift change.

### Hardware

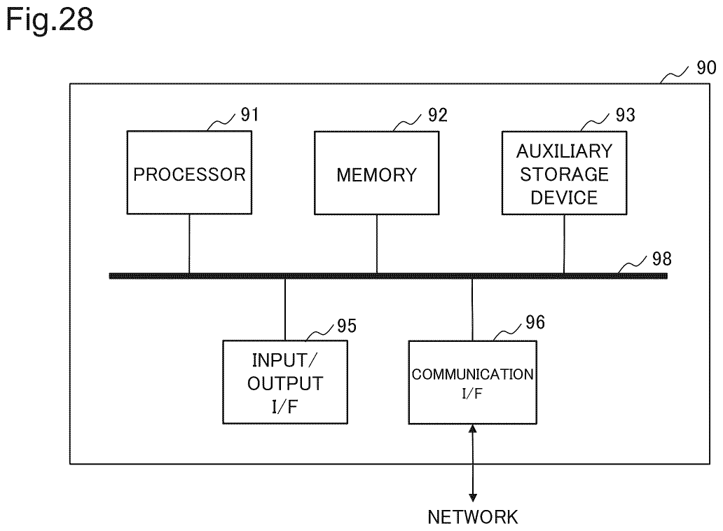

Next, a hardware configuration for executing control and process in the present disclosure will be described with reference to the drawings. Here, an example of such a hardware configuration is the information processing device 90 (computer) in FIG. 28. The information processing device 90 in FIG. 28 is a configuration example for executing control and process in the present disclosure, and does not limit the scope of the present disclosure.

As illustrated in FIG. 28, the information processing device 90 includes a processor 91, a memory 92, an auxiliary storage device 93, an input/output interface 95, and a communication interface 96. In FIG. 28, the interface is abbreviated as an interface (I/F). The processor 91, the memory 92, the auxiliary storage device 93, the input/output interface 95, and the communication interface 96 are connected to each other via a bus 98 in such a way as to be able to communicate data. In addition, the processor 91, the memory 92, the auxiliary storage device 93, and the input/output interface 95 are connected to a network such as the Internet or an intranet via the communication interface 96.

The processor 91 develops a program (command) stored in the auxiliary storage device 93 or the like in the memory 92. For example, the program is a software program for executing control and process in the present disclosure. The processor 91 executes the program developed in the memory 92. The processor 91 executes control and process in the present disclosure by executing a program.

The memory 92 is a storage device having an area in which a program is developed. A program stored in the auxiliary storage device 93 or the like is developed in the memory 92 by the processor 91. The memory 92 is achieved by, for example, a volatile memory such as a Dynamic Random Access Memory (DRAM). In addition, a nonvolatile memory such as a Magnetoresistive Random Access Memory (MRAM) may be applied as the memory 92.

The auxiliary storage device 93 stores various data such as programs. For example, the auxiliary storage device 93 is achieved by a local disk such as a hard disk or a flash memory. Various data may be stored in the memory 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface to connect to an external device.

Input devices such as a keyboard, a mouse, and a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and process in the present disclosure. The hardware configuration of FIG. 28 is an example of a hardware configuration for executing control and process in the present disclosure, and does not limit the scope of the present disclosure. A program for causing a computer to execute control and process in the present disclosure is also included in the scope of the present disclosure.

A program recording medium on which a program for executing process in the present example embodiment is recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium.

The components in the present disclosure may be optionally combined. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all the above example embodiments may be described as the following supplementary notes, but are not limited to the following.

### Supplementary Note 1

A phase shifter comprising:
an input line,
a variable phase shift circuit connected to the input line and having a line formation layer made of vanadium dioxide, and
an output line connected to the variable phase shift circuit.

### Supplementary Note 2

The phase shifter according to supplementary note 1, wherein
the variable phase shift circuit includes:
a plurality of heat generating elements arranged in an array form along one surface of the line formation layer, and
a heat generation drive circuit arranged in association with each of the plurality of heat generating elements,
each of the plurality of heat generating elements is
thermally connected to the line formation layer, and
each of the plurality of heat generation drive circuits
causes the heat generating element to generate heat to a temperature exceeding a phase transition temperature of vanadium dioxide contained in the line formation layer according to selection of the heat generating element.

### Supplementary Note 3

The phase shifter according to supplementary note 2, wherein an extended line electrically connecting the input line and the output line is formed in the line formation layer by vanadium dioxide contained in the line formation layer in contact with the heat generating element that has generated heat exceeding a phase transition temperature and undergoing phase transition to a metal phase.

### Supplementary Note 4

The phase shifter according to supplementary note 3, wherein the extended line linearly connecting the input line and the output line is formed in the line formation layer.

### Supplementary Note 5

The phase shifter according to supplementary note 3, wherein the extended line that is bent is formed in the line formation layer.

### Supplementary Note 6

The phase shifter according to supplementary note 3, wherein the extended line having an optional shape is formed in the line formation layer.

### Supplementary Note 7

The phase shifter according to supplementary note 3, wherein the heat generating elements having different shapes are combined.

### Supplementary Note 8

The phase shifter according to supplementary note 3, wherein any of the plurality of heat generating elements included in the line formation layer is disposed such that the extended line forms an arc.

### Supplementary Note 9

The phase shifter according to supplementary note 3, wherein
the heat generation drive circuit that causes the heat generating element used for forming the extended line related to a conductor pattern related to a desired phase shift amount to generate heat is selected using a phase shift table in which the conductor pattern related to the phase shift amount is registered, and
the extended line related to the conductor pattern set by using the phase shift table is formed in the line formation layer.

### Supplementary Note 10

An antenna device comprising:
the phase shifter according to any one of supplementary notes 1 to 9, and
an antenna array in which a plurality of patch antennas are arrayed in a two-dimensional array form, wherein
the phase shifter is
disposed in association with each of the plurality of patch antennas.

1. A phase shifter comprising:
an input line;
a variable phase shift circuit connected to the input line and having a line formation layer made of vanadium dioxide; and
an output line connected to the variable phase shift circuit; wherein
the variable phase shift circuit includes
a plurality of heat generating elements arranged in an array form along one surface of the line formation layer, and
a heat generation drive circuit arranged in association with each of the plurality of heat generating elements, and wherein
each of the plurality of heat generating elements is thermally connected to the line formation layer.

2. The phase shifter according to claim 1, wherein
each of the plurality of heat generation drive circuits is configured to
cause the heating element to generate heat to a temperature exceeding a phase transition temperature of vanadium dioxide contained in the line formation layer according to selection of the heat generating element.

3. The phase shifter according to claim 2, wherein
an extended line electrically connecting the input line and the output line is formed in the line formation layer by vanadium dioxide contained in the line formation layer in contact with the heat generating element that has generated heat exceeding a phase transition temperature and undergoing phase transition to a metal phase.

4. The phase shifter according to claim 3, wherein
the extended line linearly connecting the input line and the output line is formed in the line formation layer.

5. The phase shifter according to claim 3, wherein
the extended line that is bent is formed in the line formation layer.

6. The phase shifter according to claim 3, wherein
the extended line having an optional shape is formed in the line formation layer.

7. The phase shifter according to claim 3, wherein
the heat generating elements having different shapes are combined.

8. The phase shifter according to claim 3, wherein
any of the plurality of heat generating elements included in the line formation layer is disposed such that the extended line forms an arc.

9. The phase shifter according to claim 3, wherein
the heat generation drive circuit that causes the heat generating element used for forming the extended line related to a conductor pattern related to a desired phase shift amount to generate heat is selected using a phase shift table in which the conductor pattern related to the phase shift amount is registered, and
the extended line related to the conductor pattern set by using the phase shift table is formed in the line formation layer.

10. An antenna device comprising:
the phase shifter according to claim 1; and
an antenna array in which a plurality of patch antennas are arrayed in a two-dimensional array form; wherein
the phase shifter is disposed in association with each of the plurality of patch antennas.
